(19) United States
(12) Patent Application Publication
(10) Pub. No.: US 2017/0208668 A1
(43) Pub. Date: Jul. 20, 2017

(54) VEHICULAR ILLUMINATED DISPLAY SYSTEM

(71) Applicant: MotorMood, LLC, Hermosa Beach, CA (US)

(72) Inventors: Jesse D. Kramer, Hermosa Beach, CA (US); Alex G. Sewell, Chino, CA (US); Christina De Santis, Villa Park, CA (US); Arman Bastani, Costa Mesa, CA (US)

(21) Appl. No.: 14/997,816

(22) Filed: Jan. 18, 2016

(51) Int. Cl. H05B 37/02; B60Q 1/50; H05B 33/08

(52) U.S. Cl. CPC H05B 37/0272; H05B 33/0845; B60Q 1/50; B60Q 2900/30

(57) ABSTRACT

A remote controlled vehicle display system including a remote activator having an activator body and an input device adapted to receive a user input. The remote actuator further includes a transmitter adapted to generate a wireless activation signal in response to receipt of the user input. A display device is attachable to a vehicle and includes a housing including a slot formed therein. A receiver is coupled to the display housing, and is adapted to receive the wireless activation signal from the transmitter. A light source is coupled to the housing and is in operative communication with the receiver, with the light source being activated in response to receipt of the wireless activation signal by the receiver. A display insert is selectively insertable within the slot formed within the housing so as to be illuminated by the light source when the light source is activated.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to a display system, and more specifically to a remote controlled display system particularly adapted for use on a vehicle for enabling a driver to display a communication on the vehicle.

2. Description of the Related Art

The road can oftentimes feel like a hostile place full of traffic, jams and miscommunication. Drivers can easily become frustrated because of an inability to easily communicate with the drivers of adjacent vehicles. As the drivers become frustrated and hostile, their driving habits may become more dangerous. Indeed, the term “road rage” is often used to refer to extreme acts of physical assault that result from disagreements between drivers.

Drivers typically do not have a wide range of communication means at their disposal to convey a message to an adjacent driver. Rather, drivers may be resigned to relying on communication means, which are often received with negativity. For instance, when a horn is honked or lights are flashed, the driver to which that communication is conveyed may take offense, and respond in a hostile manner. For instance, the driver may tailgate the other vehicle, return flashing lights or honk the horn, or use offensive hand gestures to convey that driver's displeasure.

It has been speculated that aggressive driving oftentimes results due to a lack of consideration of the human element involved in driving. When a driver is behind the wheel, the driver may feel a false sense of control, and seldom take into account the consequences of their actions, including the safety of others on the road. Thus, even a small gesture reflecting one's human element may remind drivers to exhibit more care and concern when operating their vehicles. However, most vehicles are not equipped with a device which allows a driver to convey such simple gestures or communications to adjacent drivers.

Accordingly, there is a need for an accessory for a vehicle which allows a driver to safely and easily communicate with other drivers. Various aspects of the present disclosure address this particular need, as will be discussed in more detail below.

### BRIEF SUMMARY

In accordance with one embodiment of the present disclosure, there is provided a remote controlled vehicle display system including a remote activator having an activator body and an input device coupled to the activator body and adapted to receive an input from a user. The remote actuator further includes a transmitter operatively coupled to the input device and adapted to generate a wireless activation signal in response to receipt of the input from the user. The remote controlled vehicle display system additionally includes a display device having a housing attachable to a vehicle and including a slot formed therein. A receiver is coupled to the display housing and is adapted to receive the wireless activation signal from the transmitter. A light source is coupled to the housing and is in operative communication with the receiver, with the light source being activated in response to receipt of the wireless activation signal by the receiver. A display insert is selectively insertable within the slot formed within the housing so as to be illuminated by the light source when the light source is activated.

The input device may be configured to move relative to the activator body, with the movement of the input device relative to the activator body being correlated to the input received from, the user. The transmitter may be configured to generate the wireless activation signal using an RF communication protocol. A light emitting diode may be in communication with the transmitter and adapted to illuminate in response to generation of the wireless activation signal. A clip may be connected to the activator body, with the clip being adapted to secure the activator body to a sun visor.

The housing may include a peripheral wall having the slot extending therethrough and adapted to allow advancement of the display insert therethrough. The housing may include a rear support surface and a front rim spaced from the rear support surface, with the display insert being, sized and configured to be captured between the rear support surface and the front rim. The front rim may be disposed about an opening, with the display insert being sized and configured to extend over the opening when the display insert is inserted in the housing.

The display insert may include an emoticon depicted thereon. The display insert may also include a first tab and the housing may include a recess, with the first tab and recess being complimentary with each other, such that the first tab is received within the recess when the display insert is inserted within the housing, receipt of the first tab into the recess causing the display insert to be registered relative to the housing. The display insert may include a second tab opposite the first tab, the second tab being sized and configured to extend, from the housing when the display insert is inserted in the housing.

The light source may include a plurality of light emitting diodes. The plurality of light emitting diodes may be positioned opposite the slot. The light source may be activated for a prescribed period of time in response to the receiver receiving the wireless activation signal.

According to another aspect of the present disclosure, there is provided a remote controlled vehicle display system comprising a remote activator having an activator body, an input device coupled to the activator body and adapted to receive an input from a user, and a transmitter operatively coupled to the input device and adapted to generate a wireless activation signal in response to receipt of the input from the user. A display device is in operative communication with the remote activator, with the display device being attachable to a vehicle and capable of illuminating an icon in response to receipt of the wireless activation signal from the transmitter.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description, and drawings, in which:

FIG. 1 is a schematic representation of a remote controlled display system for a vehicle, the display system including a remote actuator and a display assembly;

FIG. 2 is a top view of the remote actuator;

FIG. 3 is a side view of the remote actuator;

FIG. 4 is a schematic view of the electrical components associated with the display system;

FIG. 5 is an exploded perspective view of the display assembly including a display device, a display insert, and a pair of adhesive clips;

FIG. 6 is a side view of the display device depicted in FIG. 5; and

FIG. 7 is a rear view of the display device depicted in FIGS. 5 and 6.

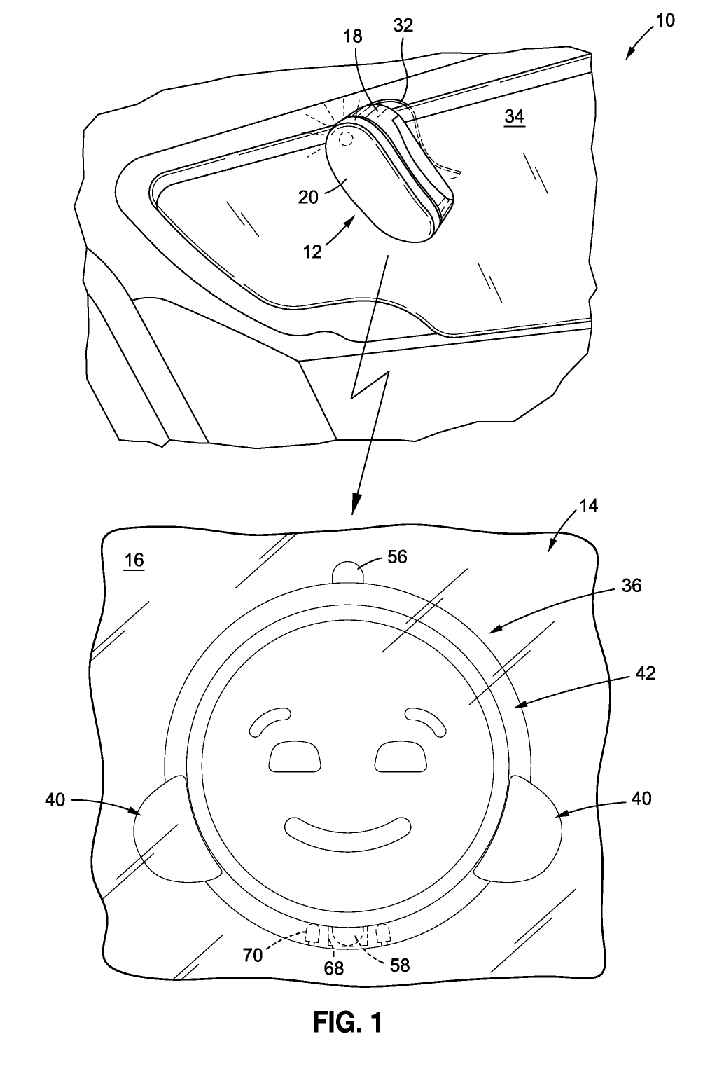

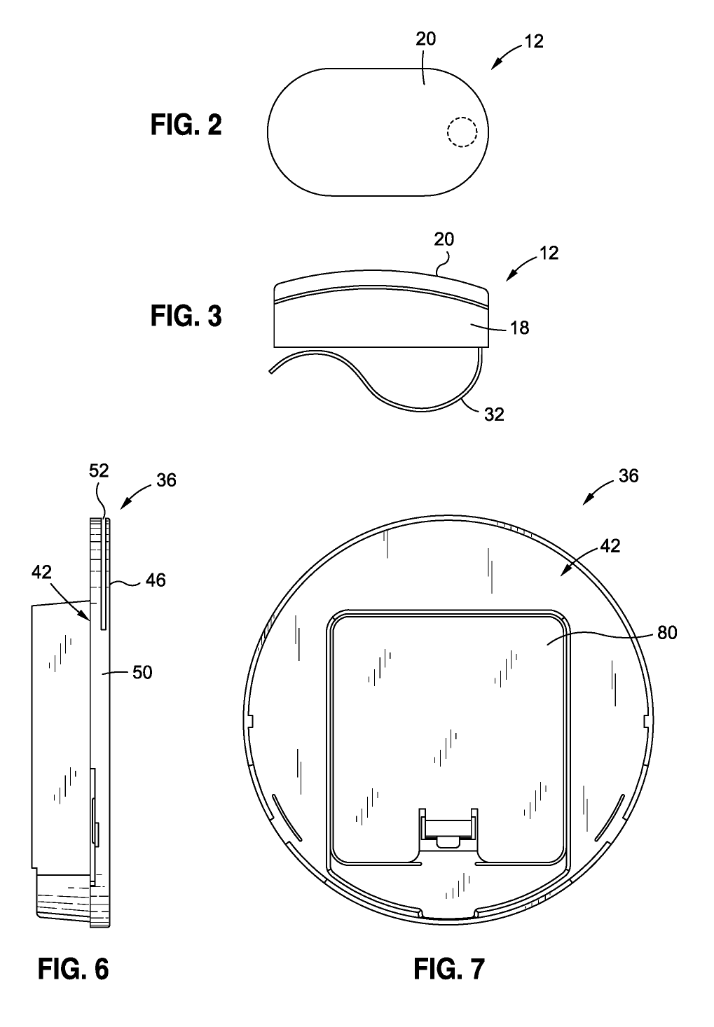

Common reference numerals are used throughout the drawings and the detailed description to indicate the same elements.

### DETAILED DESCRIPTION

The detailed description set forth below in connection with the appended drawings is intended as a description of certain embodiments of a remote controlled display system for a vehicle and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating a preferred embodiment of the present disclosure only, and are not for purposes of limiting the same, there is depicted a remote controlled vehicle display system 10 including a remote actuator 12 and a display assembly 14 capable of illuminating a display for view by passengers in an adjacent vehicle. The remote actuator 12 may be actuated by the driver and transmit a wireless activation signal, which is received by the display assembly 14, with the display being illuminated in response to receipt of the wireless activation signal by the display assembly 14. It is contemplated that the display assembly 14 may be mounted on a rear window 16 such that the illuminated display may be viewed by a person located in the vehicle behind the driver's vehicle. Therefore, if the adjacent vehicle is accommodating to, the driver, e.g., slows down to let the driver in front of the adjacent vehicle, the driver may activate the display assembly 14 to display a happy face to convey a message of thanks. Thus, despite the drivers of the two vehicles being isolated from each other in separate vehicles, the vehicle display system 10 allows the driver of the vehicle to communicate with the adjacent vehicle by selectively illuminating the display associated with the display assembly 14.

The remote activator 12 includes an activator body 18 and an input device 20 coupled to the activator body 18 and adapted to receive an input from a user. According to one embodiment, the input device 20 is configured to move relative to the activator body 18, with the movement of the input device 20 relative to the activator body 18 being correlated to the input received from the user. In this regard, the input device 20 may include a push-button which is pressed by the user to actuate the display assembly 14. In the exemplary embodiment, the input device 20 includes a cover plate that fits over the activator body 18 and moves relative thereto. The movement of the input device 20 may be translatable movement relative to the activator body 18 or pivotal movement relative to the activator body 18. Accordingly, the input device 20 may be selectively transitioned by the user between a depressed configuration and a normal configuration. When the input device 20 is in the depressed configuration, the input device 20 may interface with an electronic input sensor 22, such as a pressure activated sensor (e.g., piezo-electric sensor), to convert the mechanical motion of the input device 20 into an electronic signal. In one embodiment, at least a portion of the input device 20 moves toward the activator body 18 as the input device 20 transitions from the normal configuration toward the depressed configuration. A spring (not shown) may be coupled to input device 20 to provide a biasing force which urges the input device 20 toward the normal configuration.

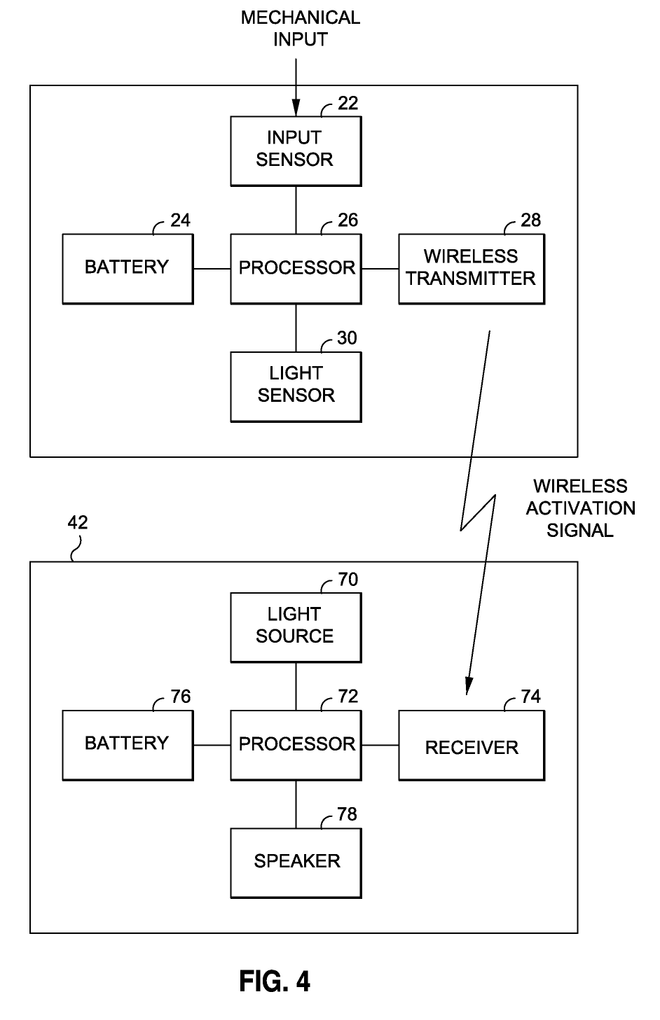

The input device 20 and activator body 18 are sized and configured to collectively define an internal cavity which houses the electronics associated with the remote actuator 12. FIG. 4 is a schematic diagram show such electrical components, including the electronic input sensor 22, a power source (e.g., battery) 24, a processor 26, a wireless transmitter 28, and a light source (e.g., light emitting diode) 30. The battery 24 provides power to the electronic input sensor 22, processor 26, wireless transmitter 28 and light source 30, and may be rechargeable or replaceable as needed to continue use of the remote actuator 12. The processor 26 is in electrical communication, with the battery 24, electronic input sensor 22, wireless transmitter 28 and light source 30 to control operation of those components. For instance, the processor 26 may deliver power from the battery 24 to the various components. The processor 26 also places the electronic input sensor 22 in operative communication with the wireless transmitter 28, such that when the electronic input sensor 22 receives input from the user (e.g., converts the mechanical motion of the input device 20 into an electrical signal), the processor 26 sends a signal to the wireless transmitter 28 which causes the wireless transmitter 28 to generate and transmit a wireless activation signal. The wireless transmitter 28 may be configured to generate the wireless activation signal using an RF communication protocol, infrared communication protocol, BLUETOOTH communication protocol, WiFi, other local area networks, or other wireless communication protocols known by those skilled in the art. The light source 30 is in, communication with the wireless transmitter 28, possibly via the processor 26, and is adapted to illuminate in response to generation of the wireless activation signal to provide a visual indicator to the user that the display assembly 14 has been activated. The light source 30 may be adapted to remain illuminated for the same period of time as the display assembly 14. In this regard, the processor 26 may include a timing circuit which controls the time which the light source 30 remains illuminated. It is understood that the light source 30 is an optional feature, and that remote activators 12 which do not include a light source 30 also fall within the scope of the present disclosure.

The remote activator 12 may further include a clip 32 may be connected to the activator body 18, with the clip 32 being adapted to secure the activator body 18 to a sun visor 34, or other structure(s) in the vehicle. The clip 32 may be formed from a resilient material, such as metal, plastic or the like, to enable to the clip 32 to hold the remote activator 12 to the sun visor.

Although the foregoing describes the remote activator 12 as being a dedicated device whose sole purpose is to perform the functionality described above, e.g., receive user input, generate the wireless activation signal, and provide a visual indicator to the user regarding the activation of the display assembly 14, it is contemplated that in other embodiments, such functionality may be performed by other electronic devices, such a smartphone, which includes the hardware necessary to perform the functions of the remote activator 12. Along these lines, a user may download a smartphone application (i.e., a smartphone “app.”), which includes the software or instructions necessary to implement the functionality on the smartphone. The smartphone app. may create a “button”/icon on smartphone's touch screen display, wherein the button operates as the input device by receiving input from the user. The smartphone app. may also use the wireless communication capabilities of the smartphone to transmit the wireless activation signal to the display assembly 14. Thus, the processing hardware on the smartphone may be capable of identifying the user input, as well as generating and transmitting the wireless activation signal to the display assembly 14.

The wireless activation signal generated by the wireless transmitter 28 is received by the display assembly 14, which illuminates the display in response to receipt of the wireless activation signal. The display assembly 14 generally includes a display device 36, a display insert 38, and one or more adhesive clips 40.

The display device 38 includes a housing 42 adapted to receive the display insert 38. According to one embodiment, the housing 42 includes a rear support surface 44 and a front rim 46 spaced from the rear support surface 44 to define a void or cavity within which the display insert 38 can be received. In this regard, the depth of the cavity (e.g., the distance between the front rim 46 and the rear support surface 44) is slightly greater than the thickness of the display insert 38. In the exemplary embodiment depicted in the Figures, the front rim 46 is circular, and includes an inner edge 48 defining a circular opening aligned with the rear support surface 44. In this respect, when the display insert 38 is not placed within the display device 36, the rear support surface 44 can be seen through the opening formed by the front rim 46. The front rim 46 extends radially outward from the inner edge 48 to a peripheral wall 50, which circumnavigates the front rim 46 and the rear support surface 44. A slot 52 extends, through the peripheral wall 50 between the front rim 46 and the rear support wall 44, and is in communication with the cavity fowled between the front rim 46 and the rear support wall 44. The slot 44 adapted to allow advancement of the display insert 38 therethrough.

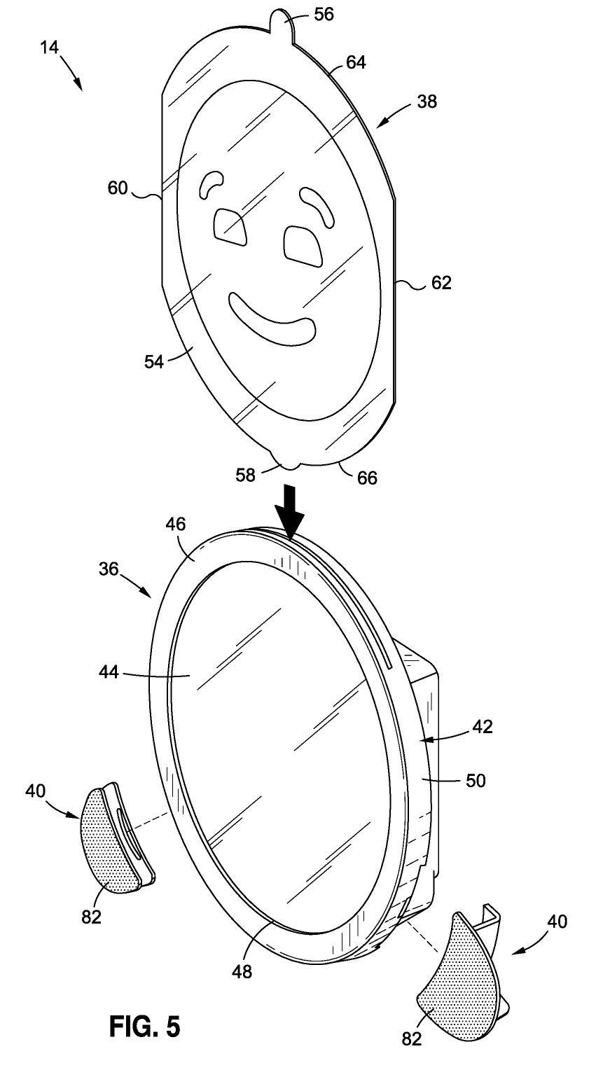

The display insert 38 is sized and configured to be captured between the rear support surface 44 and the front rim 46 and to extend over the opening defined by the front rim 46 when the display insert 38 is inserted in the housing 42. According to one embodiment, the display insert 38 comprises a main body 54, an upper tab 56, and a lower, tab 58, the importance of which will be described in more detail below. The main body 54 includes a front surface and a rear surface in opposed relation to the front surface to define an insert thickness therebetween. The main body 54 also includes a pair of side edges 60, 62, which in the exemplary embodiment are generally parallel to each other, an upper edge 64 extending between the side edges 60, 62, and a lower edge 66, also extending between the side edges 60, 62 in generally opposed relation to the upper edge 64. As depicted in FIG. 5, the upper and lower edges 64, 66 are both arcuate in shape. The main body 54 also includes a display formed therein, wherein the display may be comprised of an emoticon, icon, alphanumeric character(s), logo, or other design known by those skilled in the art. It is contemplated that the display may be printed, etched, or otherwise formed on the main body 54. It is also contemplated that the display may be printed on a separate sheet, which is later adhered or laminated onto the main body 54. In the exemplary embodiment, the display includes an emoticon of a happy face. As used herein, an emoticon is a pictorial representation, typically of a facial expression, which expresses a person's feelings or mood. Thus, the happy face depicted in the Figures is an expression of the driver being happy or thankful. However, it is understood that the display is not limited to a happy face. In particular, the display may include a sad face, a winking face, a crying face, a silly face (e.g., tongue sticking out), a seared face, an angry face, “thumbs up,” “thumbs down,” etc. Furthermore, those skilled in the art will appreciate that the display is not limited to emoticons, and may also include words, such as, “thank you” or “baby on board,” logos, such as team/college mascots, trademarks, such as the APPLE™ logo or the NIKE™ “swoosh,” any content which may otherwise be formed on a bumper sticker, or other designs or indicia.

The upper tab 56 extends from the upper edge 64 of the main body 54 in a first direction (e.g., upwardly), while the lower tab 58 extends from the lower edge 66 of the main body 54 in an opposing second direction (e.g., downwardly). In one embodiment, the upper and lower tabs 56, 58 are coaxially aligned with each other, but it is understood that in other embodiments, the tabs 56, 58 may be offset from each other. The upper tab 56 is specifically configured and adapted to provide a structure which the user may grasp to facilitate insertion and removal of the display insert 38 into and out of the housing 42. The lower tab 58 is specifically configured and adapted to cooperate with a recess 68 formed in the housing 42 to register or properly align the display insert 38 relative to the housing 42. In this regard, the lower tab 58 and the recess 68 are complimentary in shape, with the lower tab 58 being configured to be received within the housing 42. Although the exemplary embodiment includes a lower tab 58 formed on the display insert 38 and a recess 68 formed on the housing 42, it is contemplated that other embodiments may include the opposite configuration, i.e., a recess fanned along the lower edge of the display insert 38 and a corresponding a tab or protrusion formed on the housing, with the tab being specifically configured and adapted to cooperate with the recess formed in the display insert 38.

When the display insert 38 is placed in the housing, the display insert 38 may be selectively illuminated by a light source 70 which is coupled to the housing 42. According to one embodiment, the light source 70 includes a plurality of light emitting diodes (LEDs) located at the periphery of the housing 42. For instance, in one embodiment, three LEDs may be located at the bottom of the housing 42 (e.g., opposite the slot), while in other embodiments, LEDs may be spaced approximately 90 degrees from each other around the periphery of the housing 42. The number and arrangement of the LEDs may depend on the size and shape of the housing 42 and corresponding display insert 38, and thus, the present disclosure is not limited to a particular number and arrangement of LEDs.

The display device 36 includes several electrical components, including the light source 70, which enable operation of the display device 36. In particular, the display device 36 may include a processor 72, wireless receiver 74, and power source 76, in addition to the light source 70. The receiver 74 is adapted to receive the wireless activation signal from the wireless transmitter 28 of the remote activator 14. In this regard, the receiver 74 may be configured to receive wireless signals in the same communication protocol used by the wireless transmitter 28. The light source 70 is in operative communication with the receiver 74, via the processor 72, with the light source 70 being activated in response to receipt of the wireless activation signal by the receiver 74. In this regard, when the wireless activation signal is received by the receiver 74, the processor 72 may send a signal to the light source 70 to illuminate/activate the light source 70 for a prescribed period of time in response to the receiver 74 receiving the wireless activation signal. In this regard, the processor 72 may have a default setting for illuminating the light source 70 for a default time period (e.g., 5 seconds). However, it is contemplated that the processor 72 may be re-programmed by the user to illuminate the display for a different period of time. For instance, the receiver 74 may be configured to receive programming instructions sent from the user's smartphone, or other electronic device, for changing the time period that the light source 70 is illuminated. Alternatively, the display device 36 may include a programming interface (e.g., buttons) to allow a user to change the period which the light source 70 is illuminated. For instance, an “up” arrow button may be pressed to increase the illumination period, while a “down” arrow button may be pressed to decrease the illumination period.

The display device 36 may also optionally include a speaker 78 for emitting sounds from the display device 36. For instance, the speaker 78 may emit one or more beeps when the display is illuminated to alert the driver. Alternatively, the speaker 78 may play a song or emit other sounds in connection with the illumination of the display.

The power source 76 provides power to the various electrical components in the display device 36. As shown in FIG. 7, the display device 36 may include a cover 80 which covers the batteries/power source 76 during use. The cover 80 may be removed to access the batteries 76 for recharging/replacing the batteries 76.

According to one embodiment, the housing 42 is secured to the vehicle via adhesive clips 40 (e.g., securement elements), which have an adhesive face 82 that may be adhered to a rear window, tailgate, side window, or other structure on the vehicle. The adhesive clip 40 may be detachable engaged with the housing 42, via cooperating engagement elements. For instance, the clips 40 may include a tab which is received in a corresponding recess fowled on, the housing 42. Any engagement elements or devices known by those skilled in the art for attaching the clips 40 to the housing 42 may be used without departing from the spirit and scope of the present disclosure.

With the basic structure of the vehicle display system described above, the following discussion will focus on an exemplary use of the system 10. In order to use the system 10, the display device 36 is attached to the rear window, or other similar structure on the vehicle via the adhesive clips 40. The user may include several display inserts 38 from which to choose for placement into the display device 36. Once the user selects the preferred display insert 38, the selected insert 38 is advanced into, the slot 52 until the lower tab 58 registers with, the recess 58 to properly align the display insert 38 in the display device 36. The user may be required to remove another display insert 38 from the slot 52 prior to placing the preferred display insert 38 into the slot 52. To remove the display insert 38, the user pulls on the upper tab 56 to slide the display insert 38 out of the slot 52.

The remote activator 12 may be placed or secured in an easy to reach location for the driver, such as being clipped to the sun visor 34.

As the driver operates the vehicle, the driver of the subject vehicle may Want to convey a message of thanks (via a happy-face emoticon) to the driver of an adjacent vehicle. For instance, the driver of the adjacent vehicle may slow down to accommodate a lane change. Thus, the driver of the subject vehicle may press on the remote activator 12 to generate the wireless activation signal, which is received by the display device 36, and the display is illuminate for a prescribed period of time by the driver of the adjacent vehicle.

Although the foregoing describes the display assembly 14 as including a display insert 38 which is inserted into the display housing 42, it is contemplated that other embodiments of the display assembly 14 may be adapted for use without a display insert 38. For instance, certain embodiments of the display assembly 14 may include a digital display screen for depicting the display. According to one embodiment, the digital display screen may include a plurality of LEDs which may be illuminated to depict the desired display. Alternatively, the display screen may include an LCD display screen capable of depicting more detailed displays.

The particulars shown herein are by way of example only for purposes of illustrative discussion, and are not presented in the cause of providing what is believed to be most useful and readily understood description of the principles and conceptual aspects of the, various embodiments of the present disclosure. In this regard, no attempt is made to show any more detail than is necessary for a fundamental understanding of the different features of the various embodiments, the description taken with the drawings making apparent to those skilled in the, art how these may be implemented in practice.

What is claimed is:

1. A remote controlled vehicle display system comprising:
a remote activator having:
an activator body;
an input device coupled to the activator body and adapted to receive an input from a user; and
a transmitter operatively coupled to the input device and adapted to generate a wireless activation signal in response to receipt of the input from the user;
a display device having:
a housing attachable to a vehicle and having a slot formed therein;
a receiver coupled to the display housing and adapted to receive the wireless activation signal from the transmitter; and
a light source coupled to the housing and in operative communication with the receiver, the light source being activated in response to receipt of the wireless activation signal by the receiver; and
a display insert selectively insertable within the slot formed within the housing so as to be illuminated by the light source when the light source is activated.

2. The remote control vehicle display system recited in claim 1, wherein the input device is configured to move relative to the activator body, movement of the input device relative to the activator body being correlated to the input received from the user.

3. The remote control vehicle display system recited in claim 1, wherein the transmitter is configured to generate the wireless activation signal using an RF communication protocol.

4. The remote control vehicle display system recited in claim 1, further comprising a light emitting diode in communication with the transmitter, the light emitting diode being adapted to illuminate in response to generation of the wireless activation signal.

5. The remote control vehicle display system recited in claim 1, further comprising a clip connected to the activator body, the clip being adapted to secure the activator body to a sun visor.

6. The remote control vehicle display system recited in claim 1, wherein the housing includes a peripheral wall having the slot extending therethrough and adapted to allow advancement of the display insert therethrough.

7. The remote control vehicle display system recited in claim 1, wherein the housing includes a rear support surface and a front rim spaced from the rear support surface, the display insert being sized and configured to be captured between the rear support surface and the front rim.

8. The remote control vehicle display system recited in claim 7, wherein the front rim is disposed about an opening, the display insert being sized and configured to extend over the opening when the display insert is inserted in the housing.

9. The remote control vehicle display system recited in claim 1, wherein the display insert includes an emoticon depicted thereon.

10. The remote control vehicle display system recited in claim 1, wherein the display insert includes a first tab and the housing includes a recess, the first tab and recess being complimentary with each other, such, that the first tab is received within the recess when the display insert is inserted within the housing, receipt of the first tab into the recess causing the display insert to be registered relative to the housing.

11. The remote control vehicle display system recited in claim 10, wherein the display insert includes a second tab opposite the first tab, the second tab being sized and configured to extend from the housing when the display insert is inserted in the housing.

1. remote control vehicle display system recited in claim 1, wherein the light source includes a plurality of light emitting diodes.

13. The remote control vehicle display system recited in claim 12, wherein the plurality of light emitting diodes are positioned opposite the slot

14. The remote control vehicle display system recited in claim 1, wherein the light source is activated for a prescribed period of time in response to the receiver receiving the wireless activation signal.

15. A remote controlled vehicle display system comprising:
a remote activator having:
an activator body;
an input device coupled to the activator body and adapted to receive an input from a user; and
a transmitter operatively coupled to the input device and adapted to generate a wireless activation signal in response to receipt of the input from the user; and
a display device in operative communication with the remote activator, the display device being attachable to a vehicle and capable of illuminating an icon in response to receipt of the wireless activation signal from the transmitter.

16. The remote control vehicle display system recited in claim 15, wherein the input device is configured to move relative to the activator body, movement of the input device relative to the activator body being correlated to the input received from the user.

17. The remote control vehicle display system recited in claim 15, wherein the transmitter is configured to generate the wireless activation signal using an RF communication protocol.

18. The remote control vehicle display system recited in claim 15, further comprising a light emitting device in communication with the transmitter, the light emitting diode being adapted to illuminate in response, to generation of the wireless activation signal.

19. The remote control vehicle display system recited in claim 15, further comprising a clip connected to the activator body, the clip being adapted to secure the activator body to a sun visor.

20. The remote control vehicle display system recited in claim 15, further comprising a display insert selectively insertable in the display device, the icon, illuminated by the display device being located on the display insert.
